(19) United States
(12) Patent Application Publication
(10) Pub. No.: US 2002/0070705 A1
(43) Pub. Date: Jun. 13, 2002

(54) Battery charging system and method

(76) Inventors: William D. Buchanan, Fort Smith, AR (US); Joseph F. Mohos, Burbank, CA (US)

Correspondence Address: LAW OFFICE OF JOHN A. GRIECCI, 2201 E. WILLOW ST, STE D, PMB 344, SIGNAL HILL, CA, 90806-2142, US

(21) Appl. No.: 09/881,561

(22) Filed: Jun. 14, 2001

Related U.S. Application Data
(60) Provisional application No. 60/212,066, filed on Jun. 14, 2000.

(51) Int. Cl. H02J 7/00

(52) U.S. Cl. 320/116

(57) ABSTRACT

A charging system for simultaneously charging the batteries of a plurality of battery powered vehicles. The charging includes one or more DC-DC power converters having one or more charging ports configured to plug into the batteries. The DC-DC power converters are each configured to selectively connect to more than one charging port to selectively provide for higher port power levels. The DC-DC power converters connect to an AC rectifier through a DC bus. The AC rectifier connects to an AC power source having a limited power rating. The AC charging system also has a controller that controls the operation of the DC-DC power converters such that the total power draw on the AC rectifier does not exceed the power rating. The system is further configured such that the DC-DC power converters can selected drain batteries to obtain power to charge other batteries, allowing for batteries to be cycled.

The present application claims priority from a U.S. provisional patent application, Serial No. 60/212,066, filed Jun. 14, 2000, which is incorporated herein by reference for all purposes.

### BACKGROUND

This invention relates generally to battery charging systems and methods for charging batteries and, more particularly, to a cost-efficient charging system and method for simultaneously charging the batteries of a plurality of electrically powered vehicles such as forklifts.

Increasing numbers of vehicles (e.g., forklifts) are being manufactured as electric vehicles. Vehicle charging systems for the batteries of larger numbers of vehicles, such as for a fleet of forklifts vehicles, are therefor increasingly important. The implementation of such charging systems in existing facilities' electrical systems (e.g., building electrical systems) presents significant problems that can lead to large capital expenditures, as described below. Parallel Charging Facilities' electrical systems are typically formed in a multi-level, branched architecture. At each branching level, a plurality of receiving circuit breakers draws current from a distributing circuit breaker, which must have a current capacity equal to (or greater than) the sum of those of the circuit breakers that it distributes to. Each of the receiving circuit breakers in turn act as distributing circuit breakers to other circuit breakers till the end of each branch, i.e., a load such as a charging system, is reached. Because the electrical system power typically originates from an AC source, a load requiring DC power, such as a battery charger, will typically require an AC rectifier upstream from the load.

As shown in FIG. 1, an existing charging system, will typically include a system/utility circuit breaker (CB1) connected in series with a number of vehicle chargers, each of which has its own associated circuit breaker (CB2 and CB3). Each charger can charge one vehicle at a time (vehicle #1 or #2), and can operate at any current up to the limit of its associated circuit breaker. Typically the system circuit breaker has the capacity to operate at a current level up to the sum of each of the charger's circuit breakers, so the current limit of the system circuit breaker CB1 will be at or slightly over the sum of the existing associated circuit breakers CB2 and CB3.

Upgrading such a charging system to charge greater numbers of vehicles (or installing a battery charging system where none is in place) can significantly increase the current carried by the system circuit breaker, and therefore it will likely need to be upgraded to carry additional current. Increasing the maximum current capacity of the system circuit breaker (and related power transmission equipment) that supports the battery charging system requires increased capacity in each distributing circuit breaker upstream (along the circuit) from that system circuit breaker. Thus, increasing the number of vehicles that can be charged can potentially require expensive upgrading of a substantial portion of the facility's electrical system, requiring significant capital expenditures.

For example, as depicted in FIG. 1, in order to simultaneously charge additional vehicles (#4, #5 and #6), additional circuit breakers (CB4, CB5 and CB6), additional chargers and additional wiring are added to the system. The addition of these new circuits to the system requires that all name plate ratings of charging circuit breakers (CB2 to CB6) be added up to establish a new current value that the rating of the system wiring or of the system circuit breaker (CB1) cannot exceed. This is required even though the individual chargers might not all be in use at the same time and, if they are in use, they will most likely not be simultaneously operating at full power and fully utilizing the existing infrastructure. Not only will the system circuit breaker (CB1) need upgrading, but many or all of the upstream circuit breakers will need to be upgraded to support the system circuit breaker's (CB1) additional capacity. Thus, the capital expense of adding vehicle chargers to a system potentially includes the significant costs of upgrading a significant portion of the entire electrical system.

Furthermore, the batteries in each vehicle will likely have different charging requirements. For example, in FIG. 1 vehicle #1 might only need a low current for equalization, while vehicle #2 might need a larger current for fast-charging. While the chargers can be configured to handle either load level, the capacity of the charger used on vehicle #1 will be wasted even though the facility's entire electrical system was rebuilt to support the larger load.

As a result, the capital investments necessary to provide new or increased battery charging systems do not have an efficient, high and/or maximum rate of return. Additionally, where significant additional installations of battery chargers are desired, major costs might be incurred to upgrade a facility's electrical system even though the fundamental level of power available in the building is sufficient to supply the total kW hrs of power needed.

Sequential Chargers

One known approach to this problem is to install sequential chargers. Sequential chargers utilize charge capability in an improved, but not especially efficient, manner. Sequential chargers use a set of switches to connect a single charger to a series of vehicles.

As depicted in FIG. 2, with sequential chargers, additional vehicles can be added to an existing system without the need for additional current, and thus, without upgrading the entire electrical system. However, only one vehicle can be charged at a time in such a system. To the degree that this fully utilizes the facility's installed electrical system capacity for that branch, this reaches optimum usage during a normal battery charge event. However, during a typical battery charge cycle the amount of delivered current drops as the battery is more fully charged. Thus the charger will at best only fully utilize the utility during the initial stages of charging. Furthermore, where the battery charging is not a maximum level for reasons related to accommodating battery life characteristics, such as the battery voltage, charge acceptance, and optimum power, a non-optimal level will be achieved. For example temperature may limit the charge rate, SOC may limit the charge rate, or the battery charger current limit may limit the charge rate, such as when a 60 volt capable charger charges a 24 volt battery at the same current, providing a much lower power requirement.

Additionally, the contactors and wiring of the sequential chargers are large. To the degree that a certain number of vehicles must be charged in a given time, the charger capacity must be increased by a minimum of the number of vehicles. This further aggravates the first problem as a larger charger is further underutilized, and the charger's components all are larger to accommodate the higher charge rate.

Accordingly, there has existed a definite need for a cost-efficient charging system and a method for simultaneously charging a plurality of vehicles. The present invention satisfies these and other needs, and provides further related advantages.

### SUMMARY OF THE INVENTION

The present invention provides a cost-efficient charging system and a method for simultaneously charging a plurality of batteries, typically being incorporated into vehicles such as forklifts. Preferably, the present invention provides a charging system capable of limiting the power drawn from a utility, such as a facility's electrical system, to a given nameplate rating, while allocating the power to a set of connected batteries based on parameters that can be manually entered, sensed, programmed, and/or otherwise be determined.

The charging system of the invention includes one or more battery chargers, to be connected to a facility's electrical system, having one or more charging ports configured to be received by the batteries to be charged. The charging ports either connect directly to the batteries or connect to the batteries via a connection system on a device that incorporates the battery, such as a vehicle. The charging system may include a power management controller, either in a particular device or over a distributed system, and/or may include a system configured to sense a battery's charging requirements/state, either directly or via communication with the device that incorporates the battery.

An advantage of at least some embodiments of the invention is that the utility power requirements of the charging system on a facility's electrical system are managed by the power management controller to meet the facility's overall electrical system requirements by managing the load allocated to each of the charging systems' connection ports. By varying the power allocation in a logical fashion, multiple charging requirements can be met while meeting the utility power requirements.

Another advantage of at least some embodiments of the invention is that, by design, the system will be capable of simultaneous or parallel charging. This allows for various levels of charging to simultaneously occur, such as equalizing occurring on one battery while fast-charging is occurring on another. Since multiple vehicles are allowed to charge at different rates at the same time and from the same utility connection, the utility can be utilized to maximize the return on capital investment or even to prevent requiring further capital expenditures.

Yet another advantage of at least some embodiments of the invention is that they provide for selectively parallel operation of individual charging systems (e.g., individual power converters). In particular, the embodiments' internal circuitry includes switching connections such that the amount of output power to a battery can be greater than one of the charging system's power converters would normally be capable. This allows for chargers having a capacity lower than the maximum needed capacity, which lowers the cost per charger. This feature can be extended to cover a large number of power processing circuits, which could be assigned at will to an individual port to match any given power allocation strategy.

Furthermore, if power ports of the present invention are designed to be capable of both charging or discharging the electric powered vehicles, (i.e., bidirectional operating power ports), then the chargers can supplement the available utility power with power that is stored in one or more vehicles that do not presently need to be fully charged. This capability advantageously allows charging strategies wherein vehicles that are not presently in use are charged when the charging capacity is available, and are used to provide even greater capacity for charging other vehicles when capacity is needed. By employing this strategy, the charging system's capacity can be more easily scheduled to take full advantage of periods of lower charging usage. This concept can also be implemented using storage batteries that are dedicated and maintained for this purpose.

The capability of discharging one battery to provide power for another battery also advantageously provides for the energy efficient maintenance of the batteries. In particular, batteries can selectively be cycled down through a substantially drained state prior to charging so as to increase battery life, maintain maximum voltage levels and better maintain the condition of the battery. The drained power is reused in other batteries, thereby providing for energy efficiency along with battery maintenance.

Another advantage of at least some embodiments of the present invention is that the chargers, which preferably contain DC-DC converters, can have charge controllers that control the duty cycle of each converter so as to reduce the overall current harmonics that are seen by an upstream AC rectifier. Controlling the duty cycles to suppress current harmonics increases energy efficiency. Due to structural similarities, at least some embodiments of the present invention are particularly suitable to implementing this feature in a form described in U.S. Pat. No. 5,751,150, which is incorporated herein by reference.

Embodiments of the invention may also be configured to efficiently be adaptable to a wide variety of power-source configurations while maintaining the same charge-port configuration. For example, a single embodiment of the invention could be configured with a power port that accepts power at 400 Hz, 60 Hz and 50 Hz, while including modular chargers that see no difference between the different power sources.

Other features and advantages of the invention will become apparent from the following detailed description of the preferred embodiments, taken in conjunction with the accompanying drawings, which illustrate, by way of example, the principles of the invention.

### BRIEF DESCRIPTION OF THE DRAWINGS

FIG. 1 is a schematic representation of a prior art vehicle charging system that has received a first prior art form of upgrade to support additional vehicles.

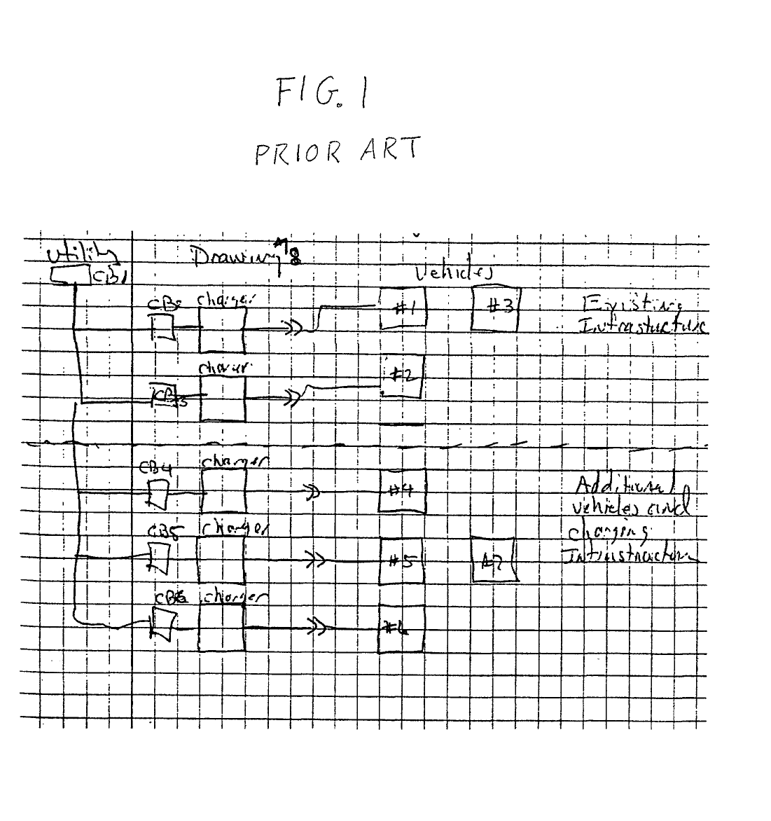

FIG. 2 is a schematic representation of a prior art vehicle charging system that has received a second prior art form of upgrade to support additional vehicles.

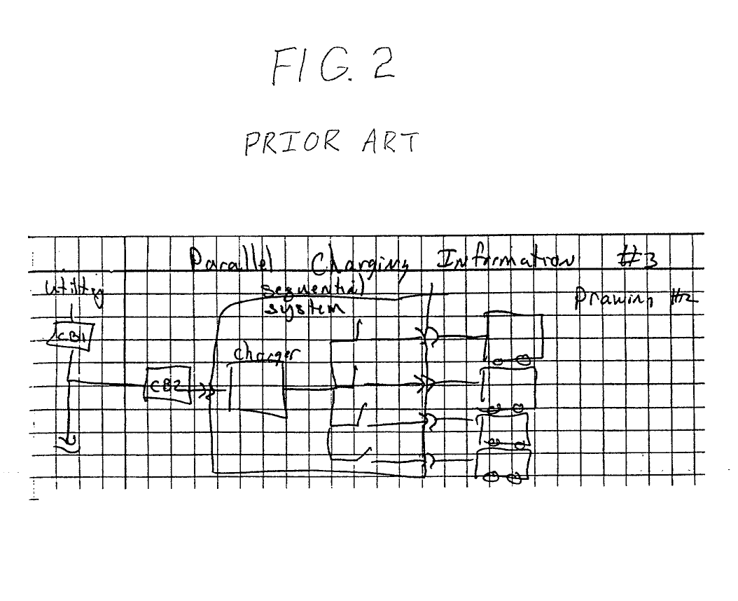

FIG. 3 is a schematic representation of a generic vehicle charging system embodying features of the present invention.

FIG. 4 is a schematic representation of an embodiment of the vehicle charging system depicted in FIG. 3.

FIG. 5 is a schematic representation of a DC module as identified in the embodiment of the vehicle charging system depicted in FIG. 4.

### DETAILED DESCRIPTION OF THE PREFERRED EMBODIMENTS

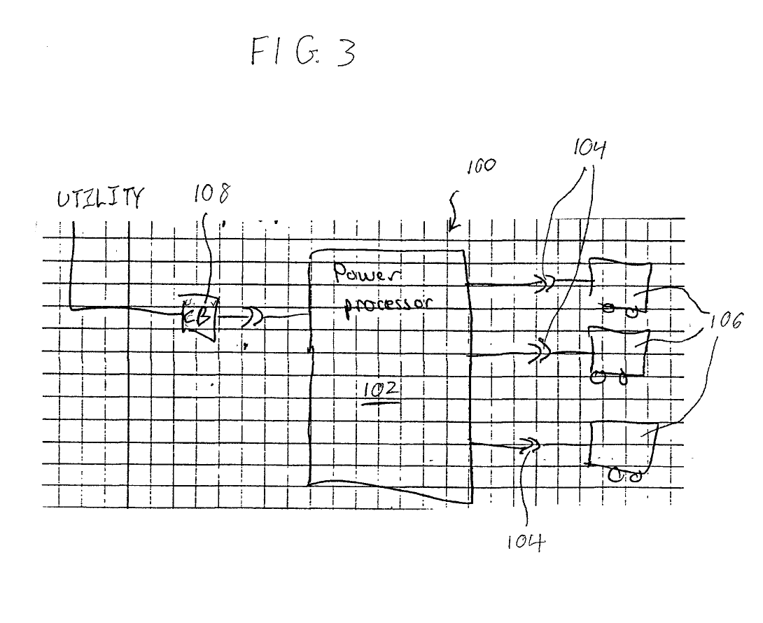

A vehicle charging system 100 according to the present invention is shown in FIG. 3. The charging system includes a power processor 102 and a series of one or more (and preferably a plurality of) ports 104 that are configured for connecting to the batteries of one or more vehicles 106. The charging system preferably receives power from a utility such as an AC electrical system, and this power is provided to the power processor through a utility's (i.e., a power system's) circuit breaker 108 that defines a total name plate current rating that is available to the charging system (or to the system and other loads that share the circuit breaker).

Other circuit breakers may be located along the electrical system, and all of these circuit breakers can be configured to limit the current passing through a wide variety of branches in the overall electrical system infrastructure. In particular, the utility circuit breaker 108 is configured such that it preferably limits the current received by the power processor 102 (and any other devices to which it provides power) to a level not exceeding the allowed portion of the requirements of the components upstream from it in the electrical system.

The power processor 102 preferably rectifies the current and manages the load allocated to each of the charging systems' ports 104. In doing so, it manages the power requirements that the charging system places on the utility so as to maintain a current level below that required by the circuit breakers and other electrical system components upstream from the charging system. By varying the power allocation between the ports in a logical fashion, multiple vehicle charging requirements can be met while meeting the upstream utility power requirements.

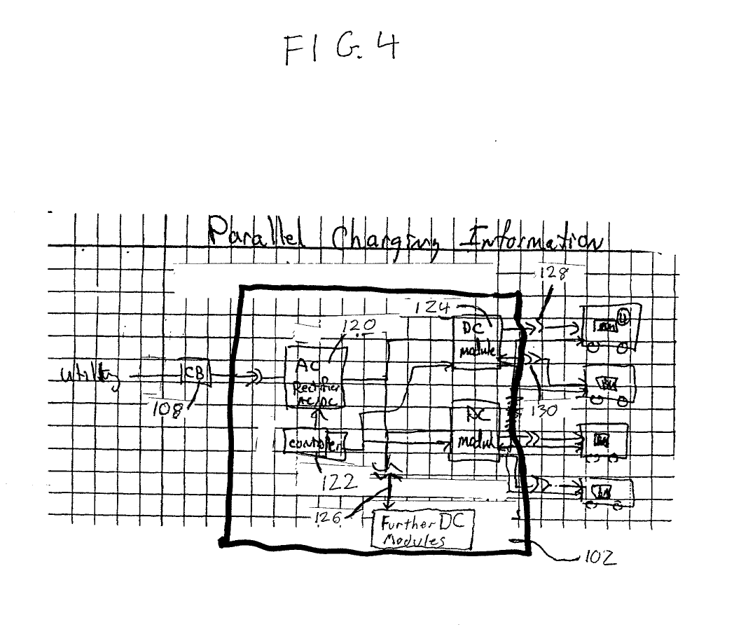

With reference to FIG. 4, the power processor 102 preferably includes an AC rectifier 120, a power controller 122 and one or more (preferably a plurality of) DC charging modules 124 that receive power from the AC rectifier over a DC bus 126. The DC modules can be, but are not necessarily, located in proximity with each other.

The AC rectifier 120 preferably converts a standard three phase alternating current from the utility's circuit breaker 108 to a regulated DC voltage. A wide array of means for rectifying are known in the industry, including those having active rectification with live commutated devices, switching devices such as IGBTs, and uncontrolled devices such as diodes. All such rectifying means are within the scope of the invention. Furthermore, if a DC source is used, no rectifying means is necessary for the operation of the invention. Alternatively, the AC rectifier can be configured to accept a variety of other currents, and can be configured to accept more than one type of current.

The power controller 122 manages the regulation and rectification of the utility's power, and can optionally regulate the DC bus 126 (in other words, the DC bus can be regulated or unregulated). The power controller also serves as a point-of-allocation for the assignment of the available power to individual DC modules 124 based on the number of vehicles, SOC (state-of charge) numbers, amp-hour charging system capacity and/or reserve capacity (as well as any other factors that might influence power requirements and availability). This information is then preferably used by each DC module to regulate the output power to one or more vehicles connected to a first and a second (or perhaps more) associated ports 128 and 130, respectively. Alternatively, the power controller could regulate the power supplied to each DC module.

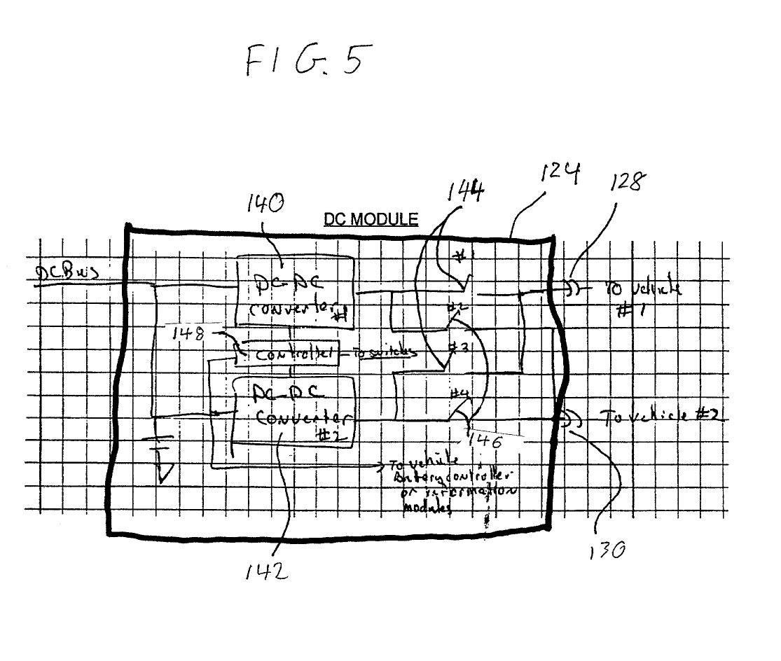

With reference to FIGS. 4 and 5, each DC module 124 of the preferred embodiment would preferably include a first DC-DC converter 140, a second DC-DC converter 142, two first connection switches 144, either one or (more preferably) two second connection switches 146, and a distribution controller 148 that is preferably in communication with the power controller 122, the DC-DC converters, the connection switches, and preferably with sensory equipment configured to sense the status of batteries connected to the first and/or second associated ports 128, 130.

In each DC module 124, the two first connection switches 144 respectively connect the first and second DC-DC converters, 140 and 142, to the first associated port 128. Likewise, the one or (preferably) two second connection switches 146 connect either one or (if there are two second connection switches) both of the first and second DC-DC converters, respectively, to the second associated port 130.

The sensory equipment preferably includes a battery monitor and/or identification controller configured to carry out a set of tasks that enables the system to operate at maximum utility. First, it preferably monitors battery features such as voltage and temperature to be used to achieve more rapid and/or efficient charge times. Second, it preferably identifies the battery's type, history and it allows for keeping track of the charge history, battery abuse events, and general data such as equalization schedules and amp-hour capacity for analysis and charge strategies. The sensory equipment can include, for example: communication equipment designed to receive communication signals from the vehicle's battery controller and/or information module; electrical test equipment configured to sense the condition of batteries over the port; and/or data entry facilities configured such that system operators can provide the information to the sensory equipment.

Based on information that the distribution controller 148 receives from the sensory equipment about the vehicles connected to the two associated ports 128, 130, the distribution controller communicates with the power controller 122 to determine the power available for charging the vehicles. Preferably that communication includes the actual connected battery information, but it could simply include a lower level of information such as the preferred power requirement. The power controller uses information from the distribution controllers for all of the DC modules to determine the power distribution that each DC module can draw.

In a DC module 124 having four switches, the distribution controller 148 can control the configuration of the switches to provide for each of the DC-DC converters 140, 142 to provide current to either (or even both) associated ports 128, 130. Thus, either each port can simultaneously receive up to the full current capacity of one DC-DC converter, or either one of the ports can receive the combined current capacity of both DC-DC converters. In a typical DC module having three switches, one port would be able to receive the combined current capacity of both DC-DC converters, while the other would only be able to receive up to the full capacity of one DC-DC converter (while the other port simultaneously received the full capacity of the other DC-DC converter).

Some alternative embodiments of DC modules can be configured with greater numbers of DC-DC converters and/or greater numbers of ports. In such embodiments, each DC-DC converter can be configured to switchably connect between one, two, three or more, and even all of the available ports in the DC module.

Based on information that the distribution controller 148 has about the vehicles connected to the two (or perhaps more) associated ports 128, 130, and based on the power availability as determined by the power controller 122, the distribution controller controls the output of each DC-DC converter. By controlling both the DC-DC controller output and the switch configuration, the distribution controller controls the charging distribution to all of the vehicles connected to the DC module's associated port's. By changing the configuration and regulating the controllers, the DC modules provide significant flexibility in charging capability. The power distribution is preferably based on a variety of factors, including each battery's: type; state of charge; port location; and charge type (e.g., equalization or fast-charging). Included in the power distribution determination are priority considerations, such as equalization's requirement for a specific current.

For example, suppose a first vehicle connected to the first associated port 128 requires an equalization, and a second vehicle connected to the second associated port 130 requires more rapid charging. Since there are two controllers with a wide range of current control this standard operation can be accomplished by having the distribution controller 148 cause the closing of one first connection switch and one second connection switch such that the first and second DC-DC converters are respectively connected to the first and second ports. The controller also causes the regulation DC-DC converters to regulate the available power, as determined by the power controller 122, accordingly by the needs of the two vehicles. If the two vehicles need more power than is available, the equalization is given priority since it requires a given level of current.

Likewise, if a first vehicle connected to the first associated port 128 requires a maximum speed charging, both of the first connection switches 144 would be closed to provide the capacity of both DC-DC converters to the vehicle. These concepts can be extended for greater numbers of DC-DC converters and/or greater numbers of ports in a DC module, providing an even greater level of flexibility while minimizing the necessary maximum capacity of any given DC-DC converter, and while maintaining the overall charging system current requirement to a minimum level.

Preferably, the control system, and more particularly the distribution controller, further acts as a charge controller to control the duty cycle of each converter so as to reduce the overall current harmonics that are seen by an upstream AC rectifier. For example, the charge controller can adjust the phase relation of the outputs by N/360° for switching events, where N is the number of DC-DC converters contained in a module. This controlling of the duty cycles to suppress current harmonics can increase energy efficiency. This is further described in U.S. Pat. No. 5,751,150, which, as noted above, is incorporated herein by reference.

Also, preferably the power ports of the present invention are designed to be capable of both charging or discharging the electric powered vehicles, (i.e., they are bidirectional operating power ports). The control system, and preferably the distribution controller can then use the switches and/or the power converters to distribute power discharged from one vehicle and supplement the available utility power to the other port and/or to the DC bus. Thus, the DC module and/or DC converters can both source and sink power.

With reference to FIGS. 3-5, in combination, the power controller 122 and the distribution controllers 148 (and any controllers related to sensing battery information) of the power processor 102 form a control system that controls the power processor to limit its utility power usage while distributing the available power to one or more batteries. It should be understood that the control system can be implemented in other ways than described above. For example, the various controllers can be combined into a controller processing unit that carries out the functions of each combined controller. Likewise, the power controller can be implemented across a series of networked control systems (e.g., the distribution controllers), such as by implementing a token control system. More broadly, any function of the control system can be dedicated to a particular processing device, or can be distributed across a number of devices.

The related method of the invention comprises various combinations of the steps carried out by the components of the above described charging system. It further includes methods carried out by charging system developers and/or charging system operators in developing, manufacturing, setting up and using the above described charging system.

In particular, one method under the invention involves:

providing a charging system configured to charge a plurality of battery systems, the charging system having a limited power usage requirement;

attaching one or more battery systems to the charging system;

controlling the distribution of power from the charging system to each attached battery such that the total power used by the charging system does not exceed the power usage requirement.

While a particular form of the invention has been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the invention. Accordingly, the invention is not intended to be limited, and can be defined with reference to the following claims, among others.

I claim:

1. A charging system for charging a plurality of batteries using power from a utility at a power level not exceeding a maximum power level, comprising:
a plurality of battery ports, each battery port being configured to electrically connect to at least one of the plurality of batteries;
a utility port configured to electrically connect to the utility, and to provide power from the utility to the plurality of battery ports; and
a system controller configured to control the power distribution between the utility port and the plurality of battery ports, wherein the controller controls the power distribution such that the plurality of batteries are charged using power from the utility at a power level not exceeding the maximum power level.

2. The charging system of claim 1, wherein the utility port is a poly-phase utility port.

3. The charging system of claim 1, wherein the utility port is configured to receive power from utilities at a plurality of power levels.

4. The charging system of claim 1, wherein the utility port is configured to provide power to the plurality of battery ports via a distribution bus, and wherein the distribution bus is configured to carry power being transferred between the plurality of battery ports.

5. The charging system of claim 1, and further comprising a first charging module, wherein the plurality of battery ports include a first battery port and a second battery port that receive power from the utility port via the first charging module, the first charging module comprising:
a first power converter connecting to the first battery port;
a second power converter connecting to the second battery port;
a crossover switch switchably connecting the first power converter to the second battery port; and
a module controller configured to control the operation of the crossover switch and establish the power distribution between the first and second battery ports.

6. The charging system of claim 5, wherein:
the first power converter of the first charging module connects to the first battery port through a first connecting switch of the first charging module;
the second power converter of the first charging module connects to the second battery port through a second connecting switch of the first charging module; and
the module controller of the first charging module is configured to control the operation of the first and second connecting switches and establish the power distribution between the first and second battery ports.

7. The charging system of claim 5, wherein
the first charging module is configured to receive DC power from the utility port;
the first power converter of the first charging module is a DC-DC power converter; and
the second power converter of the first charging module is a DC-DC power converter.

8. The charging system of claim 5, wherein the module controller for the first charging module is separate from the system controller, and wherein the system controller and the module controller for the first charging module communicate to determine the operation of the crossover switch and the first and second connecting switches.

9. The charging system of claim 5, and further comprising a second charging module, wherein the utility port is configured to provide power to a third battery port and a fourth battery port of the plurality of battery ports via the second charging module, the second charging module including:
a first power converter connecting to the third battery port;
a second power converter connecting to the fourth battery port;
a first switch switchably connecting the first power converter to the fourth battery port; and
a module controller configured to control the operation of the first switch and establish the power distribution between the first and second battery ports.

10. The charging system of claim 9, wherein:
the utility port is configured to provide DC power to each of the charging modules via a distribution bus;
the first power converter of the first charging module is a DC-DC power converter;
the second power converter of the first charging module is a DC-DC power converter;
the first power converter of the second charging module is a DC-DC power converter; and
the second power converter of the second charging module is a DC-DC power converter.

11. The charging system of claim 10, and further comprising an AC rectifier configured to receive AC current from the utility port and configured to provide DC current to the distribution bus.

12. The charging system of claim 1, wherein the plurality of battery ports include a first battery port, a second battery port, a third battery port and a fourth battery port, and further comprising:
a distribution bus;
an AC rectifier configured to receive AC power from the utility port and configured to provide DC power to the distribution bus; and
a first charging module and a second charging module, each charging module receiving power from the distribution bus, wherein
each charging module includes a first DC-DC power converter, a second DC-DC power converter, a first crossover switch, and a module controller,
the first power converter of the first charging module is connected to the first battery port,
the second power converter of the first charging module is connected to the second battery port,
the first crossover switch of the first charging module switchably connects the first power converter of the first charging module to the second battery port,
the first power converter of the second charging module is connected to the third battery port,
the second power converter of the second charging module is connected to the fourth battery port, and
the first crossover switch of the second charging module switchably connects the first power converter of the second charging module to the fourth battery port.

13. A method of charging a plurality of batteries using power from a utility at a power level not exceeding a maximum power level, comprising:
electrically connecting the plurality of batteries to a plurality of battery ports, wherein the plurality of battery ports connect to a utility port configured to electrically connect to the utility and provide power from the utility to the plurality of battery ports; and
controlling the power distribution between the utility port and the plurality of battery ports such that the plurality of batteries are charged using power from the utility at a power level not exceeding the maximum power level.
